(19) United States
(12) Patent Application Publication
(10) Pub. No.: US 2025/0291383 A1
(43) Pub. Date: Sep. 18, 2025

(54) COMPUTER SECURING APPARATUS

(71) Applicant: Elevate Home Innovations LLC, Milton, MA (US)

(72) Inventors: Christian V. Pellon, Milton, MA (US); Nicholas J. Messinger, Milton, MA (US)

(21) Appl. No.: 19/078,675

(22) Filed: Mar. 13, 2025

Related U.S. Application Data
(60) Provisional application No. 63/564,755, filed on Mar. 13, 2024.

(51) Int. Cl. G06F 1/16; H04B 1/3877

(52) U.S. Cl. CPC G06F 1/1632; H04B 1/3877

(57) ABSTRACT

A computer securing apparatus includes a securing region, an elongated region, and a device region. The securing region has a flexible clip normally biased toward a closed position and the flexible clip is configured to secure to the edge of a member or hang from a computer monitor. The device region has a base and an arm and the elongated region extends from the base. The base has a widest dimension and the arm has an arm width. The base widest dimension is greater than the arm width. The elongated region and arm form open sides and are configured to permit access when the laptop computer is supported in the device region. The base portion, the arm, or both the base and the arm are at least partially movable and normally apply a spring force toward the elongated region and are configured to removably secure a laptop computer.

### PRIORITY

This patent application claims priority from Provisional U.S. Patent Application No. 63/564,755, filed Mar. 13, 2024, entitled COMPUTER SECURING APPARATUS and naming Christian V. Pellon and Nicholas J. Messinger as the inventors, the disclosure of which is incorporated herein in its entirety, by reference.

### FIELD

Illustrative embodiments of the invention generally relate to managing desk space when using computing devices, and, more particularly, various embodiments of the invention relate to securing apparatuses for computing devices.

### BACKGROUND

The way people use laptops and other computing devices has evolved significantly. Laptops have become the central hub of personal and professional workspaces, often connected to an array of peripherals that enhance functionality and user experience. This setup typically includes external monitors, keyboards, and mice, providing a more ergonomic and efficient workspace. Additionally, users often connect to other devices like printers, external hard drives, and speakers, turning their laptop into a comprehensive workstation. This versatility is largely facilitated by docking stations or hubs, which consolidate multiple connections into a single device. These hubs allow for a seamless transition from a portable laptop to a powerful desktop-like setup, enabling users to enjoy the best of both worlds.

Undesirably, this convenience comes with its own set of challenges, notably the issue of space and clutter. When a laptop is used as the central unit in such a setup, it inevitably takes up valuable desk space. This is particularly problematic in smaller work areas or home offices where space may be at a premium. The laptop, often open for charging or quick access, adds to the physical footprint of the workstation. Furthermore, even with the use of a hub, there can be a multitude of cables connecting the laptop to its various peripherals. These cables can become entangled, creating a cluttered and disorganized appearance. This clutter not only impacts the aesthetic appeal of the workspace, but can also lead to decreased productivity and increased frustration for the user. The issue of space and cable management has become a notable concern in modern workspace design. While the use of a hub does streamline connectivity, it does not completely eliminate the problem of wires and space consumption. This challenge has led to the rise of wireless technology and the development of more compact and efficient docking solutions. However, the ideal of a completely clutter-free and minimalistic workspace remains elusive for many.

### SUMMARY OF VARIOUS EMBODIMENTS

In accordance with one embodiment of the invention, a computer securing apparatus may include an elongated body having a securing region, an elongated region, and a device region, the securing region having a flexible clip normally biased toward a closed position (“clip bias”), the flexible clip being configured to either secure to the edge of a member or hang from a computer monitor, the device region having a base and an arm extending from the base, the elongated region also extending from the base, the base having a base widest dimension, the arm having an arm width, the base widest dimension being greater than the arm width, the base widest dimension being configured to substantially stably support a laptop computer, the elongated region and arm forming open sides and configured to permit access to a laptop computer when the laptop computer is supported in the device region, the base portion, the arm, or both the base and the arm being at least partially movable and normally applying a spring force toward the elongated region and configured to removably secure a laptop computer to the elongated body.

In accordance with other embodiments, the securing region may include a trigger configured to enable a user to urge the flexible clip away from the clip bias.

In accordance with other embodiments, the base may include a substantially flat portion, where the elongated region and the arm extend from opposite sides of the substantially flat portion.

In accordance with other embodiments, the securing region may form an elongated securing chamber having a securing general direction, where the device region may form a device chamber having a device general direction, where the securing general direction intersects the device general direction.

In accordance with other embodiments, the securing general direction and device general direction may form an angle between 135 degrees and 45 degrees.

In accordance with other embodiments, the elongated region may have a bottom adjacent to the device region, the elongated region may further have a top farthest from the device region, the securing region may be a first distance from the base, the securing region may be a second distance from the top of the elongated region, and the first distance may be smaller than the second distance.

In accordance with other embodiments, the securing region may be adjacent to the device region.

In accordance with other embodiments, the elongated region may have a bottom adjacent to the device region, the elongated region may further have a top farthest from the device region, the securing region may be a first distance from the base, the securing region may be a second distance from the top of the elongated region, and the first distance may be larger than the second distance.

In accordance with other embodiments, the securing region may be adjacent to the top of the elongated region.

In accordance with other embodiments, the elongated body may be a unitary integral structure.

In accordance with other embodiments, the elongated body may have an adjustable length.

In accordance with other embodiments, the elongated region and flexible clip may be configured to cooperate to substantially stabilize the apparatus when hanging from a computer monitor.

In accordance with another embodiment, a computer securing apparatus may include an elongated body that may have a securing region, an elongated region, and a device region, the securing region may have a flexible clip normally biased toward a closed position (“clip bias”), the flexible clip may be configured to either secure to the edge of a member or hang from a computer monitor, the device region may have a base and an arm extending from the base, the elongated region also extending from the base, the base may have a base widest dimension, the securing region may have a securing region width, the base widest dimension may be greater than the securing region width, the base widest dimension may be configured to substantially stably support a laptop computer, the elongated region and arm may form open sides and be configured to permit access to a laptop computer when the laptop computer is supported in the device region, the base portion, the arm, or both the base and the arm may be at least partially movable and normally applying a spring force toward the elongated region and may be configured to removably secure a laptop computer to the elongated body.

In accordance with another embodiment, a means for securing a laptop computer to one of a member or a computer monitor may include means for one of opening a flexible clip of a securing region to grasp the member or hang the securing region over a top of the computer monitor, the flexible clip normally biased toward a closed position (“clip bias”), and a means for sliding the laptop computer into a device region coupled to the securing region by an elongated region, a width of the securing region may be less than a maximum width of the device region, and the maximum width of the device region may be configured to substantially stably support the laptop computer.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an isometric diagram illustrating an elongated body affixed to a member and a laptop computer in accordance with illustrative embodiments.

FIG. 2 schematically shows a side view of an elongated body affixed to a member and a laptop computer in accordance with illustrative embodiments.

FIG. 3A schematically shows an elongated body in accordance with a first embodiment.

FIG. 3B schematically shows an elongated body in accordance with a second embodiment.

FIG. 3C schematically shows an elongated body in accordance with a third embodiment.

FIG. 4 schematically shows an isometric diagram illustrating an elongated body in accordance with illustrative embodiments.

FIG. 5 schematically shows a computer monitor supporting a securing region in accordance with a first embodiment.

FIG. 6 schematically shows a front view of an elongated body in accordance with illustrative embodiments.

FIG. 7 schematically shows a side view of an elongated body in accordance with a fourth embodiment.

FIG. 8 schematically shows a side view of an elongated body in accordance with a fifth embodiment.

FIG. 9 schematically shows a securing region in accordance with a second embodiment.

FIG. 10 schematically shows a securing region in accordance with a third embodiment.

FIG. 11 schematically shows a flowchart in accordance with illustrative embodiments.

### DESCRIPTION OF ILLUSTRATIVE EMBODIMENTS

In illustrative embodiments, various features serve as practical and efficient solutions for optimizing workspace utilization. Its features effectively free up valuable desk space in the workspace by relocating or removing a portable computer such as a laptop computer or a tablet from a desk surface, thus catering to the needs of users with limited working areas or those desiring a more organized work environment. Additionally, the combined features contribute to the reduction and management of wiring clutter, as it facilitates the placement of the portable computer in a position that minimizes cable interference on the desk. These features not only enhance the functionality of the workspace but also contribute to a neater and more streamlined work area.

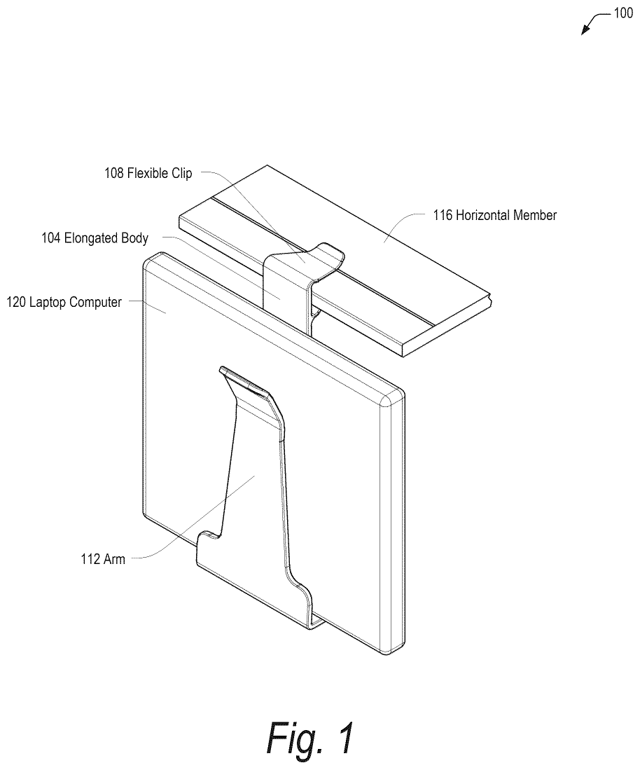

FIG. 1 schematically shows an isometric diagram illustrating an elongated body affixed to a member and a laptop computer 100 in accordance with illustrative embodiments. An elongated body 104 is generally oriented vertically to attach to a member (e.g., a desktop or horizontal member 116) for stability while grabbing a portable computer (laptop computer 120). In other embodiments, the member may be a vertical member, a slanted member, or any other form of member extending in any number of directions.

The elongated body 104 may include a flexible clip 108 to attach to the horizontal member 116 and an arm 112 to secure the laptop computer 120. This arrangement enables full use of the device 120 while minimizing the device footprint on a workspace. Details of illustrative embodiments are discussed below.

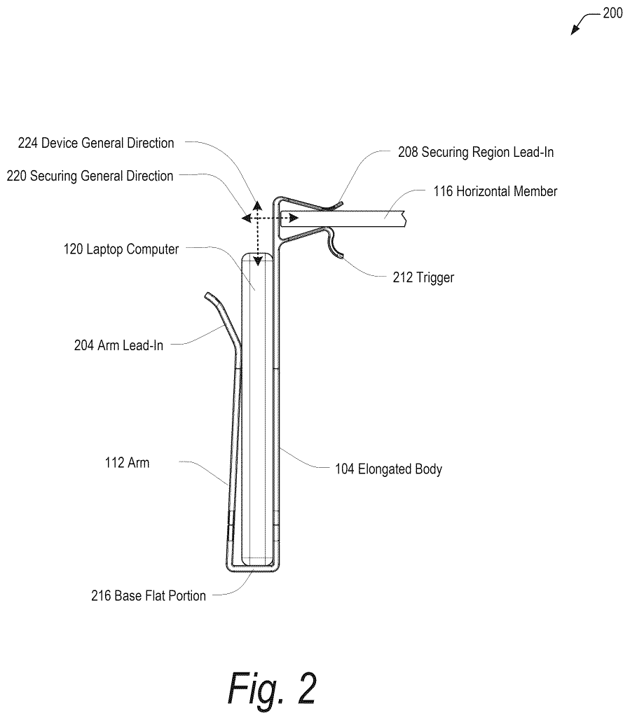

FIG. 2 schematically shows a side view of an elongated body affixed to a member and a laptop computer 200 in accordance with illustrative embodiments. FIG. 2 schematically shows a side view of the elongated body 104 in accordance with illustrative embodiments, detailing attachment to the laptop computer 120 and the horizontal member 116. This view also focuses on its adaptability and design features tailored for desktop and laptop compatibility.

In the illustrated embodiment, the flexible clip 108 may be located at a top of the elongated body 104. FIG. 2 illustrates the flexible clip 108 gripping a horizontal member 116 that is fully seated within a concave opening (“member slot”) formed by a securing region lead-in 208 and a trigger 212. The trigger 212 may be finger-actuated by a user to enlarge the opening and the securing region lead-in 208 facilitates entry of the member slot by an upper edge of the horizontal member 116. The flexible clip 108, including the securing region lead-in 208 and the trigger 212, is normally biased toward a closed position (“clip bias”).

Among other features, the elongated body 104 and the arm 112 form a crosswise slot (“device slot”) to hold the laptop computer 120. This device slot is configured to accommodate a wide range of laptop computer 120 thicknesses, such as from 0.25 inches to 1 inch (or thicker). Such versatility ensures that the elongated body 104 may be used with many laptop computers or tablets available in the market. The features take into account not only the thickness of various laptop computers 120, but also their depth and width. The arm 112 provides strong retention force, ensuring that the laptop computer 120 remains securely in place once engaged. In an embodiment, the arm 112 may terminate in an arm lead-in 204. The arm lead-in 204 may be used to separate the arm 112 from the elongated body 104 under finger or laptop computer 120 pressure and allow the laptop computer 120 to slide into the device slot between the arm 112 and the elongated body 104 from above. The arm lead-in 204 may have a large lead-in angle which is particularly beneficial for quick and minimal effort for users who need to frequently move their laptop computers 120. Additionally, the arm 112 is capable of fitting laptop computers 120 having a wide range of widths, such as from 6 to 14 inches.

At the bottom end of the elongated base 104 is a base flat portion 216, which connects the arm 112 to the bottom edge of the elongated body 104. In one embodiment, the base flat portion 216 may include a void or opening through which various cables, connectors, or other dongles (e.g., power cables, networking cables, video cables, mouse cables, keyboard cables, radio frequency (RF) wireless dongles, etc) may interface with ports on the rear surface of the laptop computer 120. The void or opening may be one physical opening or multiple openings. In one embodiment, the configuration of the openings may be specific to a manufacturer, family, or model of a laptop computer 120.

In one embodiment, the flexible clip 108 may have a securing general direction 220. For example, in the case of a horizontal member 116 (i.e., a desktop), the securing general direction 220 may be coplanar with the member slot or desktop. The laptop computer 120, when seated between the arm 112 and the elongated body 104, may have a device general direction 224 that is coplanar with the device slot and generally vertical. In this embodiment, the securing general direction 220 may intersect the device general direction 224.

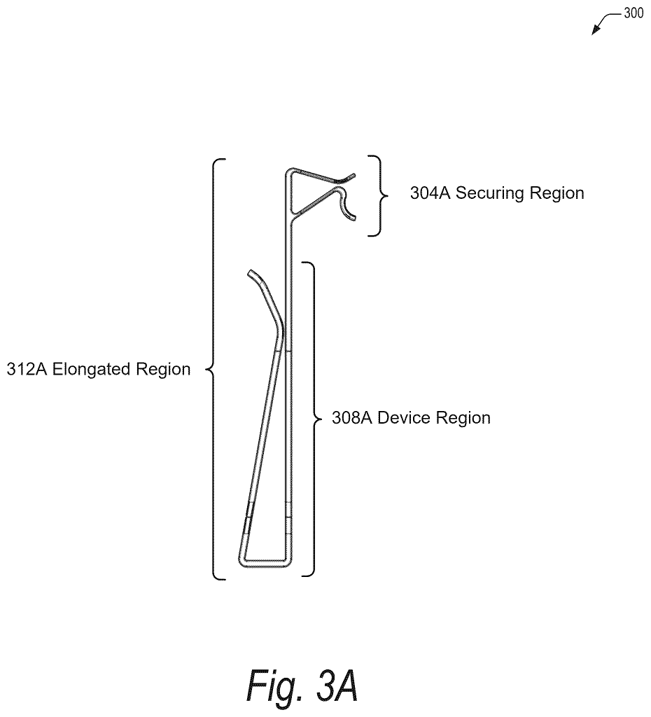

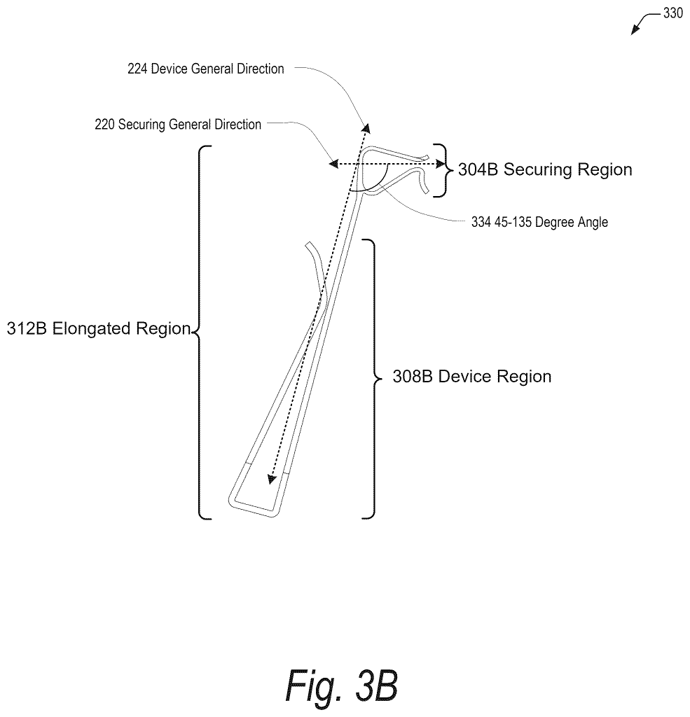

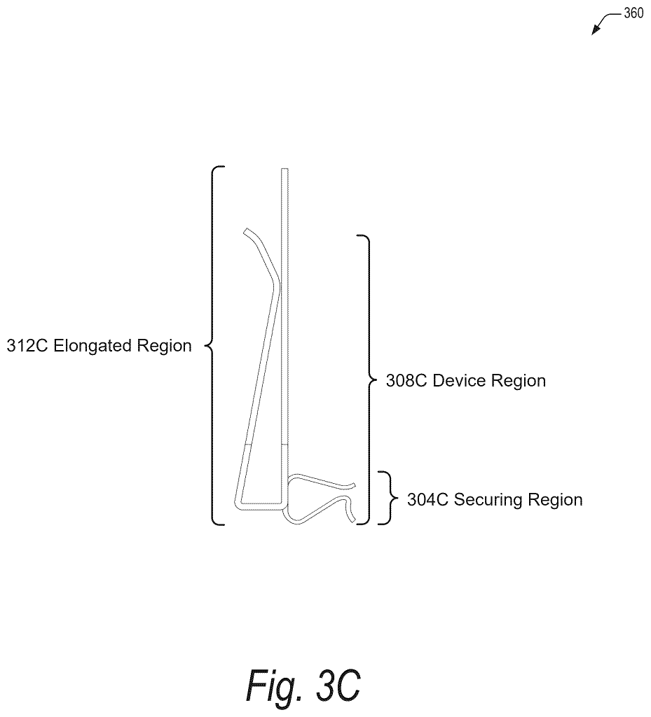

The elongated body 104 may be manufactured from various rigid materials that combine strength and support with limited areas of flexibility. For example, the elongated body 104 should preferably provide rigidity along a length of the elongated body 104 (i.e., the elongated region 312 of FIGS. 3A-3C) and between the flexible clip 108 and the bottom of the elongated body 104. There must be limited flexibility within the flexible clip 108 (such as through finger pressure applied to the trigger 212) to open the jaws of the flexible clip 108 when fastening to a member/the horizontal member 116. There must also be flexibility between the elongated region 312 and the arm 112 (such as finger pressure applied to the arm lead-in 204 when seating a laptop computer 120 within the device slot.

The elongated body 104 may be manufactured from various polymers, including ABS and PC-ABS plastics, carbon fiber materials, and certain metals such as spring steel. In plastic form, the elongated body 104 may be extruded, injection molded, 3D printed, or any other plastic-forming process. In metal form, the elongated body 104 may be laser-cut, bent, 3D-printed, or any other metal forming process. In one embodiment, the elongated body may be formed from multiple materials.

In one embodiment, the elongated body 104 may be constructed with variable material thicknesses at one or more points. For example, areas subject to bending stress may be formed thicker than areas not subject to bending stress. For example, the material at intersections between the arm 112 and the base flat portion 216, between the base flat portion 216 and the elongated region 312, between the elongated region 312 and the securing region lead-in 208, and between the elongated region 312 and the trigger 212 may be thicker than other portions of the elongated body 104.

In one embodiment, there may be one or more resilient or elastomer pads (not shown) on one or more surfaces of the elongated body 104. Softer materials may prevent scratches and other damage to desktops, monitors, other members, or laptop computers 120. For example, resilient pads may be present on internal contact surfaces of the flexible clip 108 or within the device slot. The pads may be formed as an over mold to portions of the elongated body 104 or as resilient pads that slide over portions of the flexible clip 108 and the arm 112. Such pads may also beneficially increase friction between the flexible clip 108 and the horizontal member 116 or between the arm 112 and the laptop computer 120, thereby ensuring a firmer grip and better retention. This may be a significant benefit for users who move around frequently with their laptop computer 120, as it provides additional security against slippage or accidental detachment.

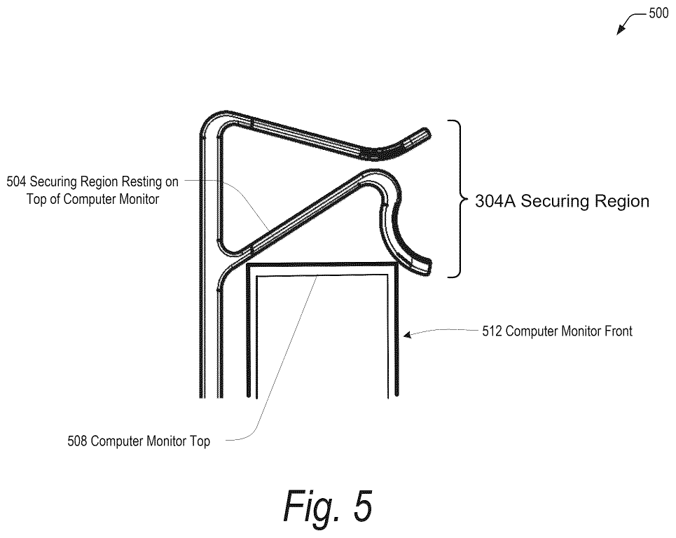

FIG. 3A schematically shows an elongated body 300 in accordance with a first embodiment. The elongated body 104 of the first embodiment 300 includes a securing region 304A, coupled to an elongated region 312A, coupled to a device region 308A. The securing region 304A attaches either to a member/horizontal member 116 or a top of a computer monitor (as shown in FIG. 5). In one embodiment, the securing region 304A may include a flexible clip 108. The securing region 304A terminates at a bottom of the trigger 212. The device region 308A is overlapped by the elongated region 312A, which extends to or past a top of the securing region 304A. The device region 308A terminates at a distal end of the arm 112 (i.e., at an end of the arm lead-in 204).

In one embodiment, the trigger 212 may be thicker or more rigid than the securing region lead-in 208, which serves dual purposes. Firstly, it functions as a lever—by placing a finger in the curved recess of the trigger 212 and squeezing, the flexible clip 108 may be easily opened and placed over a desktop's edge. This part of the clamp/hook may be intentionally made thicker to enhance rigidity, making it more effective as a lever. The remaining part of the clamp/hook (i.e., the securing region lead-in 208) is thinner, allowing it to act like a spring clamp. Additionally, the trigger 212 also may function as a hook to hang from the back of a computer monitor as shown in FIG. 5.

FIG. 3B schematically shows an elongated body 330 in accordance with a second embodiment. The elongated body 104 of the second embodiment 330 is similar to the first embodiment 300 as shown in FIG. 3A, but the securing region 304B is angled relative to the elongated region 312B and the device region 308B. This may beneficially tilt the device region 308B away from a desk and allow improved access to cables or other devices attached to the laptop computer 120. For example, the securing region 304B has a securing general direction 220 and may be tilted relative to the device general direction 224. In a preferred embodiment, the tilt angle 334 may be on/between 45 and 135 degrees.

FIG. 3C schematically shows an elongated body 360 in accordance with a third embodiment. The third embodiment 360 differs from the first embodiment 300 and the second embodiment 330 because the securing section 304C of the third embodiment 360 is affixed to the bottom of the device region 308C and the elongated region 312C, rather than the top. This arrangement allows the device slot to extend upward from the horizontal member 116, thereby locating the laptop computer 120 to extend upward from a desktop. This may allow easier access to cables and ports near the base flat portion 216 of the device slot.

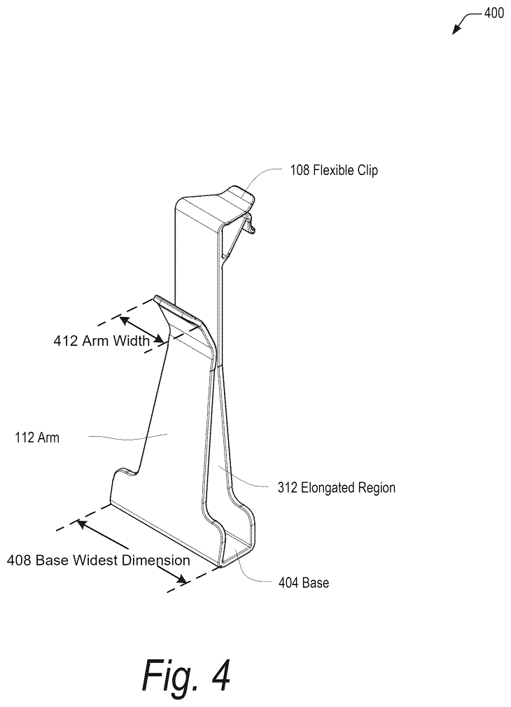

FIG. 4 schematically shows an isometric diagram illustrating an elongated body 400 in accordance with illustrative embodiments. In the illustrated embodiment, the elongated body 400 includes an elongated region 312, an arm 112, and a flexible clip 108 similar to securing region 304A of FIG. 3A. A base 404 joins a lower end of the elongated region 312 to a lower end of the arm 112.

One of the features highlighted in this view is the base widest dimension 408. The base 404 is preferably wide enough to keep the laptop computer 120 from being knocked out of the device slot easily by a passing user or tension applied to a connecting cable. For example, the base widest dimension 408 may be sized to be able to reliably support laptop computers 120 or tablets between 6 to 18 inches wide.

The arm 112 may be trapezoidal in shape (wider at the bottom, although other geometries may suffice). This specific shape is carefully chosen to optimize the retention force exerted on the laptop computer 120 and ensure that the device is held securely without risk of slipping or falling. The trapezoidal design also may play a role in minimizing the likelihood of elongated body 104 breakage, enhancing the overall durability and longevity.

In one embodiment (not shown), the arm 112 and/or the elongated region 312 may have one or more openings to reduce weight, prevent blockage of microphones or speakers of the laptop computer 120, and/or facilitate improved airflow. By facilitating better airflow around the laptop computer 120, optimal operating temperatures may be maintained.

In one embodiment, the arm 112 may have an arm width 412, for example, to be between 1-2 inches, although this range may be expanded. This size range may allow easy finger manipulation of the arm lead-in 204 when inserting or removing the laptop computer 120 to/from the device slot. In another embodiment, the securing region 304 may have a securing region width (not shown) between 1-2 inches, although this range may also be expanded. This size range is chosen to minimize the desktop space required for mounting the securing region 304/flexible clip 108, making it a useful accessory for users with limited workspace. This compact securing region 304 footprint, however, does not compromise the stability or the ability to securely hold the laptop computer 120 in place.

The open sides of the elongated region 312/arm 112 and the securing region 304 have benefits for users. First, the open sides of the securing region 304 allow for sideways adjustment along a width of the horizontal member 116. For example, this allows for avoidance of a monitor stand and other papers/items on a small desktop. The open sides of the device slot and elongated region 312 provide complete access to side-mounted cables and connectors on either side of the laptop computer 120, allowing for uninterrupted connectivity. Additionally, rear-mounted cables and connectors may be adjusted for available openings on the bottom of the base 404 by sliding the laptop computer 120 to the left or right within the device slot. Finally, the open sides facilitate ventilation of the laptop computer 120 itself.

The elongated body's design offers versatility in terms of its manufacturing process and adaptability to different user needs. As noted above, it may be constructed as a unitary body using conventional injection molding, extrusion, or other processes. For example, injection molding is well-suited for low-cost mass production and involves melting plastic material and injecting it into a pre-designed mold, where it cools and solidifies into the final shape of the product. This process is highly efficient for producing complex shapes with a high degree of precision and consistency, making it useful for consistency of the elongated body's design features. Other benefits of a unitary body design means the elongated body 104 would be a single, solid piece, offering robustness and durability. This approach simplifies the manufacturing process and reduces the number of moving parts, minimizing the potential for mechanical failures and ensuring a longer lifespan for the product. Other embodiments can form the elongated body 104 with additive printing processes (e.g., three dimensional printing).

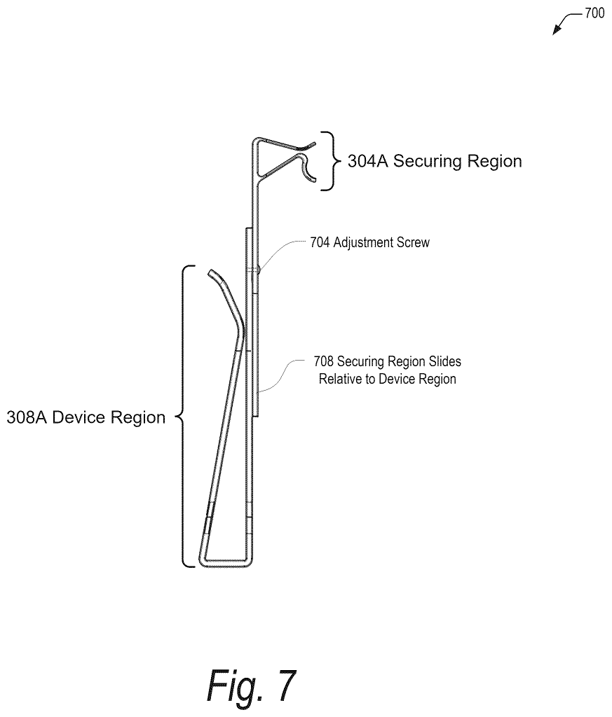

In one embodiment, the device region 308 of the elongated body 104, which holds the laptop computer 120, is also designed with adjustability in mind. This adaptability is useful to accommodate laptops of various sizes and thicknesses. For example, the base 404 may include adjustable upper and lower portions configured to slide depth-wise relative to each other to accommodate laptop computers 120 of varying thicknesses. One of the upper or lower portions may be formed as part of the elongated region 312 while the other of the upper and lower portions may be formed as part of the arm 112. An adjustment screw may be used to secure the upper and lower portions to each other at a desired depth, as shown in FIG. 7.

In another embodiment, a mechanism for adjusting the device slot may involve sliding arms or an expandable frame, allowing the user to modify the size of the device slot to fit their specific laptop computer 120. This adjustment ensures that the laptop computer 120 sits securely within the elongated body 104, regardless of its size. As with other embodiments, the adjustable device slot may also feature protective resilient or elastomeric material to prevent any scratches or damage to the laptop computer 120, and to provide extra grip to keep the laptop computer 120 firmly in place.

FIG. 5 schematically shows a computer monitor supporting a securing region 500 in accordance with a first embodiment. The securing region 304A shown in FIG. 3A includes an upper portion including a securing region lead-in 208 and a trigger 212. In some cases, it may be preferable to hang the securing region 304A over a top of a computer monitor 508 such that the elongated body 104 hangs over a rear of the computer monitor, extending downward, and the computer monitor front 512 (i.e., displaying surface) projects images from the opposite side. Therefore, the securing region rests on top of the computer monitor 504. This arrangement may be preferable where a horizontal member 116 (e.g., desktop) is unavailable such as the case where the computer monitor is wall mounted.

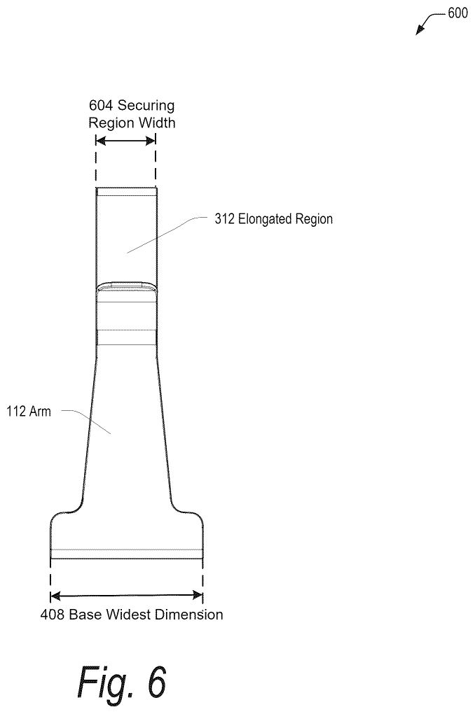

FIG. 6 schematically shows a front view of an elongated body 600 in accordance with illustrative embodiments. The front view of the elongated body 104 shows the arm 112 coupled to the elongated region 312 through the base 404. In one embodiment, the base 404 may have a base widest dimension 408 and the securing region 304 has a securing region width 604. The base widest dimension 408 may be wider than the securing region width 604 to provide good support for laptop computers 120 while taking minimum desktop or horizontal member 116 space.

FIG. 7 schematically shows a side view of an elongated body 700 in accordance with a fourth embodiment. The fourth embodiment of the elongated body 700 is similar to the first embodiment shown in FIG. 3A but includes an upper portion that includes the securing region 304A and a lower portion that includes the device region 308A. The securing region slides relative to the device region 708. In one embodiment, a vertical overlaying slot may be provided in the upper and lower portions and an adjustment screw 704 may secure the upper portion to the lower portion when the adjustment screw 704 is tightened. In another embodiment (not shown), the upper portion may slide vertically relative to the lower portion and may be captured to the lower portion at discrete intervals by detents, cutouts, or the like. The discrete intervals may provide adjustments to vary the length of the elongated body 104 to accommodate different sizes of laptop computers 120 and avoid possible interference with portions of a computer monitor or computer monitor stand, a horizontal member 116, a vertical member, any cables, or walls or other surfaces in close proximity.

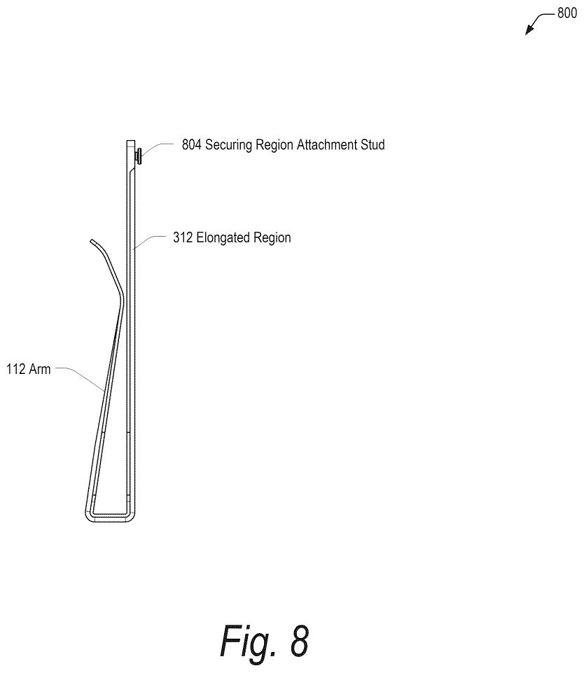

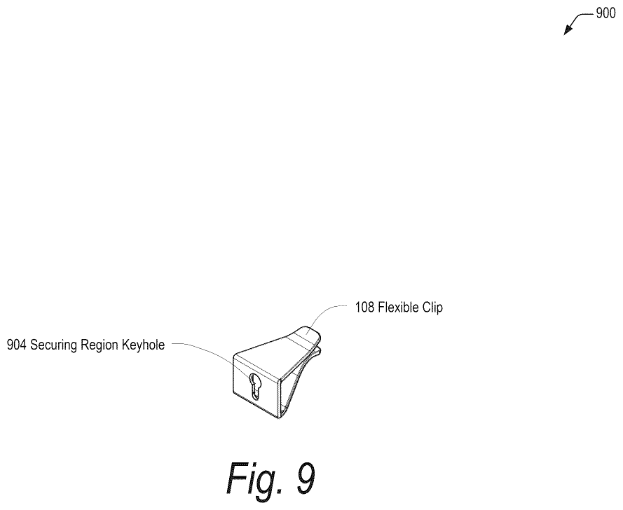

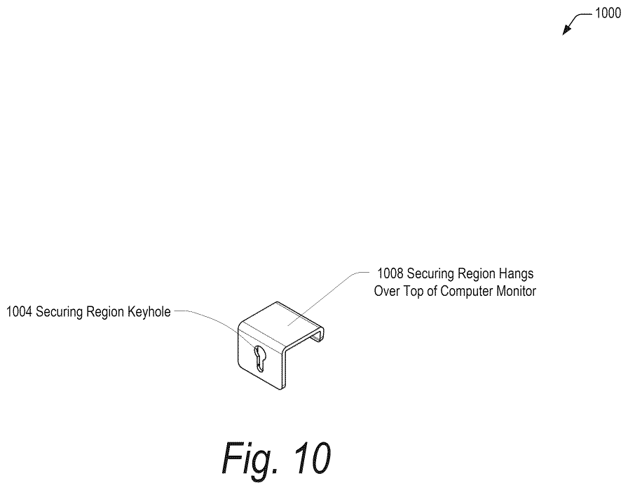

FIG. 8 schematically shows a side view of an elongated body 800 in accordance with a fifth embodiment. The fifth embodiment breaks the elongated body 104 into multiple components: an elongated region 312 and a separate securing region (see FIGS. 9 and 10). In another embodiment, the arm 112 may be a separate component as well, allowing different base 404 widths to accommodate differently sized laptop computers 120. In the illustrated embodiment, the arm 112 is attached to the elongated region 312. This may allow different lower and upper sections to be used to customize the laptop computer 120 size or tablet size as well as method of attachment to the horizontal member 116 or computer monitor.

Various forms of attachment may be used to couple the upper section (securing region 304) to the lower section (arm 112 and elongated region 312). In the illustrated embodiment, a top end of the elongated region 312 may include a securing region attachment stud 804. The securing region attachment stud 804 may engage a matching recess in the securing region 304 to couple the upper section to the lower section. Other forms of retention clips, fasteners, or hooks may be used to couple the upper section to the lower section.

FIG. 9 schematically shows a securing region 900 in accordance with the fifth embodiment. The securing region of the fifth embodiment 900 is intended to engage a lower portion of a multi-part elongated body 104, such as the elongated body 800 of FIG. 8. These forms of adjustable components provide a versatile and adaptable way to adapt to various desks and other members (e.g., to a slanted or vertical member). In the illustrated embodiment, the securing region 900 may include a keyhole slot that engages and mates with the securing region attachment stud 804 of FIG. 8. The stud 804 passes through the upper part of the securing region keyhole 904. The elongated body 800 holds the laptop computer 120 and the weight/gravity pulls the stud 804 downward in the securing region keyhole 904 where the stud 804 is captured by the narrower section of the securing region keyhole 904. To separate the elongated body 800 from the securing region 900, the elongated body 800 (possibly capturing a laptop computer 120, or not) is lifted upward a small amount, until the stud 804 is aligned with the upper hole of the securing region keyhole 904. At that point, the elongated body 800 may be pulled straight backward to separate the elongated body 800 from the securing region 900.

FIG. 9 illustrates a flexible clip 108 configuration of a securing region 304. However, modularity may be enhanced by using different securing regions. For example, alternate securing regions 900 may be wider, taller, longer, have a narrower or wider opening, use different materials and have different clamping forces, include different forms of resilient or elastomeric pads, or be suitable to coupling to different arrangements of vertical members, horizontal members, or slanted or curved members. Some embodiments of securing regions 900 may include various adjustment mechanisms, such as adjustment screws, sliding sections, or tabs to couple multiple securing regions 900 or elongated bodies 800 together.

Different securing regions 900 may be made from different materials, have different weights, different colors, different textures, and/or different levels of adjustability. Another advantage of a modular securing region 900 or modular elongated body 800 is simple replacement in case of damage. For example, a user may force the arm 112 too far from the elongated region 312 to accommodate a very thick laptop computer 120 and break the connection.

FIG. 10 schematically shows a securing region 1000 in accordance with the fifth embodiment. The fifth embodiment 1000 is an alternative to the modular securing region 900 shown in FIG. 9 and the one-piece securing region 500 shown in FIG. 5, and is intended more specifically for over-monitor mounting. A flatter top portion and more pronounced forward lip may provide more secure attachment to a computer monitor rather than the lead-in 208 and trigger 212. The securing region 1000 may include a securing region keyhole 1004 that may function the same as the securing region keyhole 904 shown in FIG. 9. The securing region hangs over the top of the computer monitor 1008.

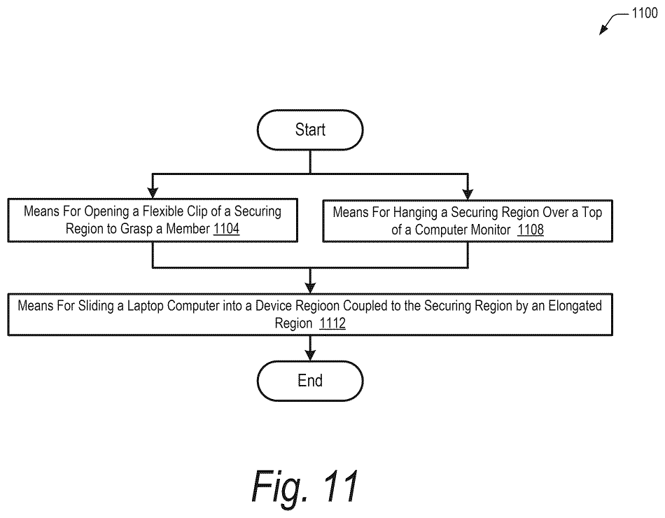

FIG. 11 schematically shows a flowchart 1100 in accordance with illustrative embodiments. Flow begins at either block 1104 or block 1108.

At block 1104, a means for opening a flexible clip 108 of a securing region 304 is provided. The means may include any manual process such as pinching one or more members together, separating one or more members from each other, or sliding or twisting one or more members with respect to each other. Flow proceeds to block 1112.

At block 1108, a means for hanging a securing region over a top of a computer monitor is provided. The means may include any manual process for lifting at least the securing region 500, 900, 1000 over the top of a computer monitor 508, extending the securing region 500, 900, 1000 forward such that a projection of the securing region 500, 900, 1000 (e.g., the trigger 212) is forward of a front surface of the computer monitor 512, and lowering the securing region 500, 900, 1000 until the projection rests against the front of the computer monitor 512 and a top surface of the securing region 500, 900, 1000 is supported by the top of the computer monitor 508. Flow proceeds to block 1112.

At block 1112, a means for sliding a laptop computer 120 into a device region 308 coupled to a securing region 304 by an elongated region 312 is provided. A laptop computer 120 may be pressed downward to engage a lead-in 204 of an arm 102, causing the arm 102 to separate from the elongated region 312. The laptop computer 120 may be pressed downward further until the laptop computer 120 is seated against the base 404. At the point, the laptop computer 120 is secured within the device region 308. The elongated body 104 is fully installed and ready for use. Flow ends at block 1112.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, solid state drive, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink rapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

What is claimed is:

1. A computer securing apparatus comprising:
an elongated body having a securing region, an elongated region, and a device region,
the securing region having a flexible clip normally biased toward a closed position (“clip bias”), the flexible clip being configured to either secure to the edge of a member or hang from a computer monitor,
the device region having a base and an arm extending from the base, the elongated region also extending from the base,
the base having a base widest dimension, the arm having an arm width, the base widest dimension being greater than the arm width, the base widest dimension being configured to substantially stably support a laptop computer,
the elongated region and arm forming open sides and configured to permit access to a laptop computer when the laptop computer is supported in the device region,
the base portion, the arm, or both the base and the arm being at least partially movable and normally applying a spring force toward the elongated region and configured to removably secure a laptop computer to the elongated body.

2. The computer securing apparatus as defined by claim 1, wherein the securing region comprises a trigger configured to enable a user to urge the flexible clip away from the clip bias.

3. The computer securing apparatus as defined by claim 1, wherein the base comprises a substantially flat portion, the elongated region and the arm extending from opposite sides of the substantially flat portion.

4. The computer securing apparatus as defined by claim 1, wherein the securing region forms an elongated securing chamber having a securing general direction, further wherein the device region forms a device chamber having a device general direction, the securing general direction intersecting the device general direction.

5. The computer securing apparatus as defined by claim 4, wherein the securing general direction and device general direction form an angle between 135 degrees and 45 degrees.

6. The computer securing apparatus as defined by claim 1, wherein the elongated region has a bottom adjacent to the device region, the elongated region further having a top farthest from the device region,
the securing region being a first distance from the base,
the securing region being a second distance from the top of the elongated region,
the first distance being smaller than the second distance.

7. The computer securing apparatus as defined by claim 6, wherein the securing region is adjacent to the device region.

8. The computer securing apparatus as defined by claim 1, wherein the elongated region has a bottom adjacent to the device region, the elongated region further having a top farthest from the device region,
the securing region being a first distance from the base,
the securing region being a second distance from the top of the elongated region,
the first distance being larger than the second distance.

9. The computer securing apparatus as defined by claim 6, wherein the securing region is adjacent to the top of the elongated region.

10. The computer securing apparatus as defined by claim 1, wherein the elongated body is a unitary integral structure.

11. The computer securing apparatus as defined by claim 1, wherein the elongated body has an adjustable length.

12. The computer securing apparatus as defined by claim 1, wherein the elongated region and flexible clip are configured to cooperate to substantially stabilize the apparatus when hanging from a computer monitor.

13. A computer securing apparatus comprising:
an elongated body having a securing region, an elongated region, and a device region,
the securing region having a flexible clip normally biased toward a closed position (“clip bias”), the flexible clip being configured to either secure to the edge of a member or hang from a computer monitor,
the device region having a base and an arm extending from the base, the elongated region also extending from the base,
the base having a base widest dimension, the securing region having a securing region width, the base widest dimension being greater than the securing region width, the base widest dimension being configured to substantially stably support a laptop computer,
the elongated region and arm forming open sides and configured to permit access to a laptop computer when the laptop computer is supported in the device region,
the base portion, the arm, or both the base and the arm being at least partially movable and normally applying a spring force toward the elongated region and configured to removably secure a laptop computer to the elongated body.

14. The computer securing apparatus as defined by claim 13, wherein the securing region comprises a trigger configured to enable a user to urge the flexible clip away from the clip bias.

15. The computer securing apparatus as defined by claim 13, wherein the base comprises a substantially flat portion, the elongated region and the arm extending from opposite sides of the substantially flat portion.

16. The computer securing apparatus as defined by claim 13, wherein the securing region forms an elongated securing chamber having a securing general direction, further wherein the device region forms a device chamber having a device general direction, the securing general direction intersecting the device general direction.

17. The computer securing apparatus as defined by claim 16, wherein the securing general direction and device general direction form an angle between 135 degrees and 45 degrees.

18. The computer securing apparatus as defined by claim 13, wherein the elongated region has a bottom adjacent to the device region, the elongated region further having a top farthest from the device region,
the securing region being a first distance from the base,
the securing region being a second distance from the top of the elongated region,
the first distance being smaller than the second distance.

19. The computer securing apparatus as defined by claim 18, wherein the securing region is adjacent to the device region.

20. The computer securing apparatus as defined by claim 13, wherein the elongated region has a bottom adjacent to the device region, the elongated region further having a top farthest from the device region,
the securing region being a first distance from the base,
the securing region being a second distance from the top of the elongated region,
the first distance being larger than the second distance.

21. The computer securing apparatus as defined by claim 20, wherein the securing region is adjacent to the top of the elongated region.

22. The computer securing apparatus as defined by claim 13, wherein the elongated body is a unitary integral structure.

23. The computer securing apparatus as defined by claim 13, wherein the elongated body has an adjustable length.

24. The computer securing apparatus as defined by claim 13, wherein the elongated region and flexible clip are configured to cooperate to substantially stabilize the apparatus when hanging from a computer monitor.

25. A means for securing a laptop computer to one of a member or a computer monitor, comprising:
means for one of opening a flexible clip of a securing region to grasp the member or hang the securing region over a top of the computer monitor, the flexible clip normally biased toward a closed position (“clip bias”); and
means for sliding the laptop computer into a device region coupled to the securing region by an elongated region, a width of the securing region being less than a maximum width of the device region, the maximum width of the device region being configured to substantially stably support the laptop computer.
